(19) United States
(12) Patent Application Publication
(10) Pub. No.: US 2023/0371546 A1
(43) Pub. Date: Nov. 23, 2023

(54) MULTILAYERED CONFECTIONARY

(71) Applicant: Ferrara Candy Company, Chicago, IL (US)

(72) Inventor: Tiffany Ruhl, Chicago, IL (US)

(21) Appl. No.: 18/318,915

(22) Filed: May 17, 2023

Related U.S. Application Data
(60) Provisional application No. 63/344,099, filed on May 20, 2022.

(51) Int. Cl. A23G 3/54; A23G 3/44

(52) U.S. Cl. CPC A23G 3/54; A23G 3/44

(57) ABSTRACT

The present disclosure is directed to a multilayered confectionary with a colloid blend that includes gelatin and pectin and methods of making the multilayered confectionary. The multilayered confectionary has two non-aerated layers, a first layer and a second layer having different attributes, the multilayered confectionary formed by pre-gelling the colloid blend.

### RELATED APPLICATIONS

The present patent application claims the priority benefit of U.S. Provisional Patent Application Ser. No. 63/344,099, filed May 20, 2022, the content of which is hereby incorporated by reference in its entirety into this disclosure.

### BACKGROUND

Gelled “gummy” confectionary products are widely known as chewy candies with a springy, resilient character with varying degrees of firmness. These confectionary products are often made with gelatin or gelatin alternatives, corn syrup and/or sugar, and starches.

These gummy confectionary products, also referred to as gummies or gummy candies, may include sweet and sour gummy candies in various shapes, including various animals, hands, stars, and other shapes. Although some of these gummy candies provide flavor combinations or specialty textures, further improvements in texture and flavor combinations are possible.

### BRIEF SUMMARY

Traditionally gummy candies have been made primarily with gelatin or gelatin alternatives, corn syrup and/or sugar, and starches. These gummy candies typically have a harder chew and, over time, can harden. While pectin produces softer gummy candies, pectin often pre-gels, making it harder to produce a finished product. Additionally, there is a desire to develop layered gummy candies with different attributes on each layer. A need exists for multilayered gummy confectionary products that have a softer bite and provide at least two different acid levels, flavor combinations, appearances, and/or colors.

An aspect of the present disclosure is a multilayered confectionary including a colloid blend; the colloid blend includes gelatin and pectin, wherein the multilayered confectionary has at least two layers, a first layer and a second layer having different attributes, and the at least two layers are formed by pre-gelling the colloid blend.

An aspect of the present disclosure is a multilayered confectionary including a colloid blend, the colloid blend including gelatin and pectin, wherein the multilayered confectionary comprises no more than two non-aerated layers, a first layer and a second layer, each layer having at least two different attributes, wherein at least one of the attributes is pH, and the pH of the first layer is lower than the pH of the second layer, and the first layer and the second layer are formed by pre-gelling the colloid blend.

Another aspect of the disclosure is a method of preparing multilayered confectionary, including providing a colloid blend including gelatin and pectin and pre-gelling the colloid blend to form at least two layers, wherein a first layer and a second layer have different attributes.

Another aspect of the disclosure is a method of preparing a multilayered confectionary including a colloid blend, the colloid blend including gelatin and pectin, wherein the multilayered confectionary comprises no more than two non-aerated layers, a first layer and a second layer, each layer having at least two different attributes, wherein at least one of the attributes is pH, and the pH of the first layer is lower than the pH of the second layer, and the first layer and the second layer are formed by pre-gelling the colloid blend.

In some aspects, the colloid blend has at least about 5% pectin, alternatively at least about 7% pectin, alternatively at least about 9% pectin, alternatively at least about 10% pectin, alternatively at least about 15% pectin, alternatively at least about 20% pectin, alternatively at least about 25% pectin, alternatively at least about 30% pectin, alternatively at least about 35% pectin, alternatively at least about 40% pectin, alternatively at least about 45% pectin, alternatively at least about 50% pectin, alternatively at least about 55% pectin, alternatively at least about 60% pectin, alternatively at least about 65% pectin, alternatively at least about 70% pectin, alternatively at least about 75% pectin, alternatively at least about 80% pectin, alternatively at least about 85% pectin, alternatively at least about 90% pectin, alternatively at least about 95% pectin.

In another aspect, the colloid blend comprises about 95% or less of gelatin, alternatively about 90% or less of gelatin, alternatively about 85% or less of gelatin, alternatively about 80% or less of gelatin, alternatively about 75% or less of gelatin, alternatively about 70% or less of gelatin, alternatively about 65% or less of gelatin, alternatively about 60% or less of gelatin, alternatively about 55% or less of gelatin, alternatively about 50% or less of gelatin, alternatively about 45% or less of gelatin, alternatively about 40% or less of gelatin, alternatively about 35% or less of gelatin, alternatively about 30% or less of gelatin, alternatively about 25% or less of gelatin, alternatively about 20% or less of gelatin, alternatively about 15% or less of gelatin, alternatively about 10% or less of gelatin, alternatively about 5% or less of gelatin.

In some aspects, the attributes include pH, color, texture, flavor, appearance, taste, and aroma. In another aspect, the pH of the first layer is from about 2.5 to about 4.0, and the pH of the second layer is from about 3.2 to about 5.0. In another aspect, attribute is appearance wherein the first layer is translucent and the second layer is opaque or the first layer is opaque and the second layer translucent.

In some aspects, the colloid blend is pre-gelled by adjusting the gelling temperature. In another aspect, the colloid blend is pre-gelled by adding at least one salt, at least one acid, and/or at least one solid to the colloid blend. In another aspect, the salt is selected from the group including a citrate salt, a phosphate salt, a malate salt, or combinations thereof. In yet another aspect, the acid is selected from the group including acetic acid, ascorbic acid, butyric acid, citric acid, tartaric acid, malic acid, lactic acid, fumaric acid, and combinations thereof.

These features are pointed out with particularity in the claims annexed hereto and forming a part hereof. These and other advantages, aspects, and novel features of the present disclosure, as well as details of illustrated aspects thereof, will be more fully understood from the following description and drawings.

### BRIEF DESCRIPTION OF THE DRAWINGS

Referring now to the drawings wherein like reference numerals and letters indicate corresponding structure throughout the several views:

FIG. 1 is a side view of a multilayered confectionary according to an aspect of this disclosure. Two distinct layers with different attributes (e.g., opaque layer and translucent layer) are shown.

FIG. 2 is a top view of a multilayered confectionary according to an aspect of this disclosure.

FIG. 3 is a bottom view of a multilayered confectionary according to an aspect of this disclosure.

### DETAILED DESCRIPTION

Unless otherwise defined, all technical and scientific terms used herein have the same meaning as commonly understood by one of ordinary skill in the art to which the methods described herein belong. Any reference to standard methods (e.g., ASTM, TAPPI, AATCC, etc.) refers to the most recent available version of the method at the time of filing of this disclosure unless otherwise indicated.

For any method disclosed herein that includes discrete steps, the steps may be conducted in any feasible order. And, as appropriate, any combination of two or more steps may be conducted simultaneously.

All headings are for the convenience of the reader and should not be used to limit the meaning of the text that follows the heading, unless so specified.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements.

By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The singular form “a”, “an” and “the” include plural referents unless the context clearly dictates otherwise. These articles refer to one or to more than one (i.e., to at least one). As used herein, the term “or” is generally employed in its usual sense including “and/or” unless the content clearly dictates otherwise. The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

Where ranges are given, endpoints include all numbers subsumed within that range (e.g., 1 to 5 includes 1, 1.5, 2, 2.75, 3, 3.80, 4, 5, etc.). Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise. Herein, “up to” a number (for example, up to 50) includes the number (for example, 50). The term “in the range” or “within a range” (and similar statements) includes the endpoints of the stated range.

Reference throughout this specification to “one aspect,” “an aspect,” “certain aspects,” or “some aspects,” etc., means that a particular feature, configuration, composition, or characteristic described in connection with the aspect is included in at least one aspect of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more aspects.

Unless otherwise indicated, all numbers expressing quantities of components, molecular weights, and so forth used in the specification and claims are to be understood as being modified in all instances by the term “about.” As used herein in connection with a measured quantity, the term “about” refers to that variation in the measured quantity as would be expected by the skilled artisan making the measurement and exercising a level of care commensurate with the objective of the measurement and the precision of the measuring equipment used. The term “about” as used in connection with a numerical value throughout the specification and the claims denotes an interval of accuracy, familiar and acceptable to a person skilled in the art. In general, such interval of accuracy is +/−10%. Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

The term “exemplary” means serving as a non-limiting example, instance, or illustration. As utilized herein, the terms “e.g.,” and “for example” set off lists of one or more non-limiting aspects, examples, instances, or illustrations.

As used herein, the term “substantially” refers to the qualitative condition of exhibiting total or near-total extent or degree of a characteristic or property of interest. Biological and chemical phenomena rarely, if ever, go to completion and/or proceed to completeness or achieve or avoid an absolute result. The term “substantially” is therefore used herein to capture the potential lack of completeness inherent in many biological and chemical phenomena. For example, “substantially” may refer to being within at least about 20%, alternatively at least about 10%, alternatively at least about 5% of a characteristic or property of interest.

The invention is defined in the claims. However, below is a non-exhaustive listing of non-limiting exemplary aspects. Any one or more of the features of these aspects may be combined with any one or more features of another example, embodiment, or aspect described herein.

The disclosure provides for a multilayered confectionary which includes a colloid blend. The colloid blend includes gelatin and pectin. Gelatin is a hydrogel that is commonly found in the gel matrix material in gummies and chewy confectionary products. Pectin is a soluble fiber that is often used as a gelling agent in gummies and chewy confectionary products. This colloid blend allows for the production of a multilayer confectionary has at least two distinct layers. In an embodiment, the multilayer confectionary has no more than two district layers. In some embodiments, the distinct layers have no bleeding or substantially no bleeding of components into another. The multilayered confectionary is stable (i.e., have no bleeding or substantially no bleeding of components into another) for at least about 1 month, alternatively for at least about 2 months, alternatively for at least about 3 months, alternatively for at least about 4 months, alternatively for at least about 6 months, alternatively for at least about 7 months, alternatively for at least about 8 months, alternatively for at least about 9 months, alternatively for at least about 10 months, alternatively for at least about 11 months, alternatively for at least about 12 months, alternatively for at least about 13 months, alternatively for at least about 14 months, alternatively for at least about 15 months, alternatively for at least about 16 months, alternatively for at least about 17 months, alternatively for at least about 18 months, alternatively for at least about 19 months, alternatively for at least about 20 months, alternatively for at least about 21 months, alternatively for at least about 22 months, alternatively for at least about 23 months, alternatively for at least about 24 months, alternatively for at least about 2 years, alternatively for at least about 3 years, alternatively for at least about 4 years, or alternatively for at least about 5 years.

Traditional multilayered confectionaries are typically produced using thickeners such as starch and/or gelatin or aeration. A starch/gelatin blend creates a more viscous candy slurry that is not as prone to mixing. Aeration aids in layering by incorporating air into the slurry to create a difference in density, the resulting gummy has an inflated texture, similar to a marshmallow, and lacks the chew of the disclosed multilayered confectionary.

Aeration also results in the formation of opaque layers. As such, if a multilayered confectionary has two or more aerated layers, achieving two different attributes in each layer would be difficult. If one layer of the multilayered confectionary was aerated, during the manufacturing process the aerated layer would rise to the top of a multilayered confectionary due to the density differences. This results in a striated confectionary where streaks of the aerated layers are deposited in the non-aerated layer. The novel colloid blend allows for the production of a multilayered confectionary where each layer is non-aerated and has different and distinct attributes.

In one aspect, a logo, image, text, or design can be printed on an outward facing surface of one of the layers. By avoiding aeration, the first deposit/bottom layer of deposit can be opaque, highlighting additional details printed into the starch. If aeration were used to create the multilayered confectionary, the bottom layer would always be the opaque layer even if deposited it as the first layer. This is due to difference in densities which cause the less dense layer to “float” to the top of the deposit/bottom layer of candy. As such, if aeration were used, the only way to achieve an opaque layer as the first deposit would be to add an additional compound such as an oxide, a modified starch, a carbonate, and/or a phosphate. In addition to affecting the stability, consistency, and/or vibrancy of the multilayered confectionary, it would still result in a multilayered confectionary with two opaque layers. This is in contrast to a disclosed embodiment of the multilayered confectionary which has one opaque layer and one translucent or transparent layer. A “transparent layer” means a layer that allows light to pass through without appreciable scattering of light. Often the transparent layer appears clear. A “translucent layer” means a layer that allows light to pass through with some refraction of light. A translucent layer may be slightly transparent, meaning that objects cannot be seen, but not clearly, through the layer. A translucent layer may appear somewhat cloudy or coated. An “opaque layer” means a layer that is impenetrable to light and objects cannot be seen through the layer. An opaque layer may be a solid color.

The gelatin/pectin found in the disclosed colloid blend, which has a lower viscosity slurry and does not hinder manufacturing. To form the multiple layers and impart a soft chew, the multilayered confectionary is pre-gelled. While the colloid blend creates a lower viscosity candy slurry that does not hinder manufacturing, the lower viscosity makes it difficult to maintain multi-layering. While pre-gelling is typically avoided in gummy production and considered a negative result when using pectin, pre-gelling was forced to manufacture the multilayered confectionary and used as an unexpected advantage.

Pectin is a gelling agent that is very sensitive to specific parameters, including, but not limited to, pH, temperature, the degree of methoxylation of the pectin, the total soluble solids content (Brix), the concentration of buffer salts, the type of buffer salts, and/or the type of sugar. If any one of these parameters is out of the acceptable range for pectin, the product will begin to form its gel matrix. Pectin creates a non-thermoreversible gel, so once the pectin is set it cannot be broken and reformed. Pre-gelling allows for the separation of layers in the multilayered confectionary. Pre-gelling creates a semi-solid layer of candy that keeps the layers separated from each other. Without pre-gelling the layers, the different layers would fully bleed and migrate into one another.

The pectin may be high methoxyl (HM) pectin or low methoxyl (LM) pectin. The degree of methoxylation is expressed as a percentage of esterified galacturonic acid units to total galacturonic acid units in the molecule of pectin. Amidated pectin can be produced by partial amidation of the unesterified carboxyl groups. The pectin may be unbuffered or buffered (e.g., including salts or other buffering agents).

In some aspects, the pectin begins to gel when the temperature is less than about 106° C., alternatively less than about 105° C., alternatively less than about 104° C., alternatively less than about 103° C., alternatively less than about 102° C., alternatively less than about 101° C., alternatively less than about 100° C., alternatively less than about 99° C., alternatively less than about 98° C., alternatively less than about 97° C., alternatively less than about 96° C., alternatively less than about 95° C., alternatively less than about 94° C., alternatively less than about 93° C., alternatively less than about 92° C., alternatively less than about 91° C., alternatively less than about 90° C., alternatively less than about 89° C., alternatively less than about 88° C., alternatively less than about 87° C., alternatively less than about 86° C., alternatively less than about 85° C., alternatively less than about 84° C., alternatively less than about 83° C., alternatively less than about 82° C., alternatively less than about 80° C., alternatively less than about 79° C., alternatively less than about 78° C., alternatively less than about 77° C., alternatively less than about 76° C., alternatively less than about 75° C., alternatively less than about 74° C., alternatively less than about 73° C., alternatively less than about 72° C., alternatively less than about 71° C., alternatively less than about 70° C., alternatively less than about 69° C., alternatively less than about 68° C., alternatively less than about 67° C., alternatively less than about 66° C., alternatively less than about 65° C., alternatively less than about 64° C., alternatively less than about 63° C., alternatively less than about 62° C., alternatively less than about 61° C., alternatively less than about 60° C., alternatively less than about 59° C., alternatively less than about 58° C., alternatively less than about 57° C., alternatively less than about 56° C., alternatively less than about 55° C., alternatively less than about 54° C., alternatively less than about 53° C., alternatively less than about 52° C., alternatively less than about 51° C., or alternatively less than about 50° C.

In some aspects, the pectin begins to gel at a pH of about 3.8 or lower, alternatively at a pH of about 3.7 or lower, alternatively at a pH of about 3.6 or lower, alternatively at a pH of about 3.5 or lower, alternatively at a pH of about 3.4 or lower, alternatively at a pH of about 3.3 or lower, alternatively at a pH of about 3.2 or lower, alternatively at a pH of about 3.1 or lower, alternatively at a pH of about 3.0 or lower, alternatively at a pH of about 2.9 or lower, alternatively at a pH of about 2.8 or lower, alternatively at a pH of about 2.7 or lower, alternatively at a pH of about 2.6 or lower, alternatively at a pH of about 2.5 or lower, alternatively at a pH of about 2.4 or lower, alternatively at a pH of about 2.3 or lower, alternatively at a pH of about 2.2 or lower, alternatively at a pH of about 2.1 or lower, or alternatively at a pH of about 2.0 or lower.

In an aspect, pre-gelling occurs at a pH between about 2.0—about 3.8 and a temperature of about 50° C. to about 90° C. In an aspect, the pre-gelling occurs at a pH of between about 3.7—about 3.2 and a temperature of about 60° C. to about 80° C.

The ratio of gelatin to pectin in the colloid blend is dependent on how the layering is formed. In some aspects, the colloid blend may include at least about 5% pectin, alternatively at least about 7% pectin, alternatively at least about 9% pectin, alternatively at least about 10% pectin, alternatively at least about 15% pectin, alternatively at least about 20% pectin, alternatively at least about 25% pectin, alternatively at least about 30% pectin, alternatively at least about 35% pectin, alternatively at least about 40% pectin, alternatively at least about 45% pectin, alternatively at least about 50% pectin, alternatively at least about 55% pectin, alternatively at least about 60% pectin, alternatively at least about 65% pectin, alternatively at least about 70% pectin, alternatively at least about 75% pectin, alternatively at least about 80% pectin, alternatively at least about 85% pectin, alternatively at least about 90% pectin, alternatively at least about 95% pectin. In some aspects, the colloid blend may include about 95% or less of gelatin, alternatively about 90% or less of gelatin, alternatively about 85% or less of gelatin, alternatively about 80% or less of gelatin, alternatively about 75% or less of gelatin, alternatively about 70% or less of gelatin, alternatively about 65% or less of gelatin, alternatively about 60% or less of gelatin, alternatively about 55% or less of gelatin, alternatively about 50% or less of gelatin, alternatively about 45% or less of gelatin, alternatively about 40% or less of gelatin, alternatively about 35% or less of gelatin, alternatively about 30% or less of gelatin, alternatively about 25% or less of gelatin, alternatively about 20% or less of gelatin, alternatively about 15% or less of gelatin, alternatively about 10% or less of gelatin, alternatively about 5% or less of gelatin.

In an aspect, the colloid blend includes about 80% gelatin, alternatively about 81% gelatin, alternatively about 82% gelatin, alternatively about 83% gelatin, alternatively about 84% gelatin, alternatively about 85% gelatin, alternatively about 86% gelatin, alternatively about 87% gelatin, alternatively about 88% gelatin, alternatively about 89% gelatin, alternatively about 90% gelatin, alternatively about 91% gelatin, alternatively about 92% gelatin, alternatively about 93% gelatin, alternatively about 94% gelatin, or alternatively about 95% gelatin.

In an aspect, the colloid blend includes about 5% pectin, alternatively about 6% pectin, alternatively about 7% pectin, alternatively about 8% pectin, alternatively about 9% pectin, alternatively about 10% pectin, alternatively about 11% pectin, alternatively about 12% pectin, alternatively about 13% pectin, alternatively about 14% pectin, alternatively about 15% pectin, alternatively about 16% pectin, alternatively about 17% pectin, alternatively about 18% pectin, alternatively about 19% pectin, or alternatively about 20% pectin.

Various processing parameters were considered to maintain processing capabilities while intentionally pre-gelling the colloid blend slurry. If the slurry pre-gels too much, it can clog piping and create significant manufacturing issues. If the slurry doesn't pre-gel enough, the layering is not maintained.

In some embodiments, the percent of pectin and percent of gelatin present in the colloid blend add up to 100%. In other embodiments, the percent of pectin and the percent of gelatin present in the colloid blend do not add up to 100%. In these embodiments, the colloid blend may further include at least one buffer, acid, and/or solid. The addition of these buffers, acids and/or solids to the colloid blend slurry assists in the production of multiple non-aerated layers where each layer has at least one attribute. Additionally, temperature may be used to pre-gel the slurry to produce multiple layers. The salts and acids listed are only a few examples that may be added to the colloid blend slurry to achieve multiple layers. In some non-limiting examples, the salt is a citrate salt, a phosphate salt, a malate salt, or combinations thereof. The acid may be, for example, acetic acid, ascorbic acid, butyric acid, citric acid, tartaric acid, malic acid, lactic acid, fumaric acid, and combinations thereof.

Other components may be added to the multilayer confectionary, including, but not limited to, water, sugar, artificial sweeteners, natural sweeteners, corn syrup, glucose syrup, maple syrup, high fructose corn syrup, flavors, colors, coatings, glazes and/or edible waxes.

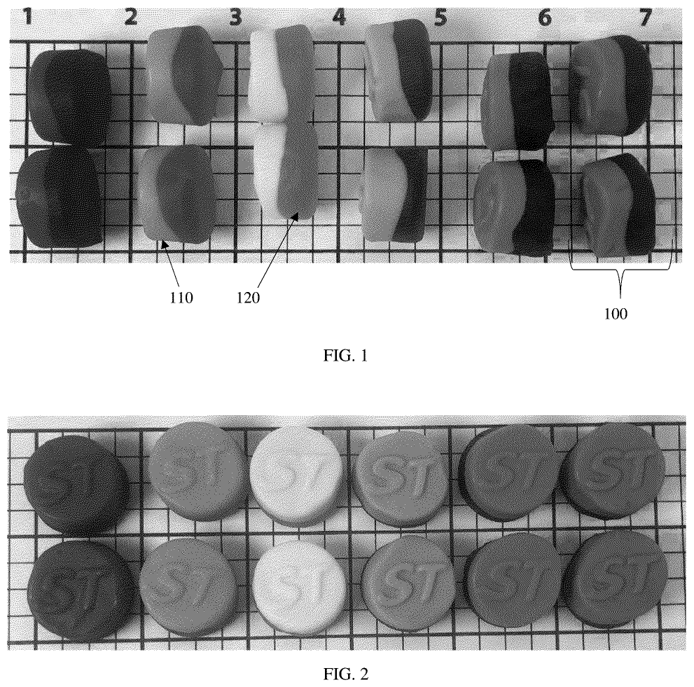

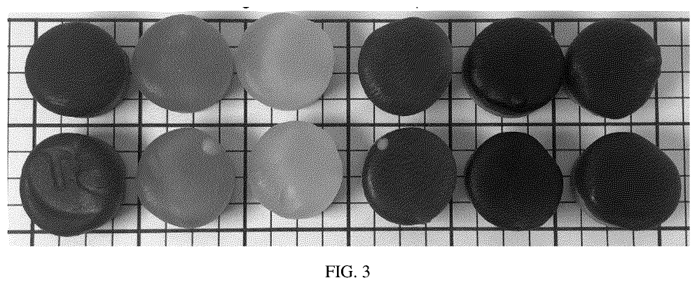

FIGS. 1-3 show a multilayered confectionary 100 according to an aspect of this disclosure. In this non-limiting example, the multilayered confectionary 100 has a first layer 110 and a second layer 120. The first layer 110 and the second layer 120 have different attributes. As shown in FIG. 1, the first layer 110 is opaque and the second layer 120 is translucent.

In some aspects, the attributes of the layers can be controlled to match or mismatch thereby providing a new and unique sensory experience. This includes, but is not limited to, different pH, different colors, different textures, different flavors, different appearances, different tastes, and/or different aromas. In some aspects, each different color may have an associated fruit flavor. For example, green candy elements may be lime or sour apple, red elements may be cherry or strawberry, blue elements may be raspberry, orange elements may be orange, purple elements may be grape, yellow elements may be lemon, etc.

In an aspect, the first layer and the second layer have a different pH. In some embodiments, the first layer and second layer have a different pH and at least a second different attribute, alternatively at least a third different attribute, alternatively at least a fourth different attribute, alternatively at least a fifth different attribute, alternatively at least a sixth different attribute, alternatively at least a seventh different attribute.

In an embodiment, the first layer has both a different pH and color than the second layer. In another embodiment, the first layer has a different pH, color, and texture than the second layer. In another embodiment, the first layer has a different pH, color, texture, and flavor than the second layer. In another embodiment, the first layer has a different pH, color, texture, flavor, and appearance than the second layer. In another embodiment, the first layer has a different pH, color, texture, flavor, appearance, and taste than the second layer. In another embodiment, the first layer has a different pH, color, texture, flavor, appearance, taste, and aroma than the second layer. In an embodiment, the first layer is translucent and the second layer is opaque. In another embodiment, the first layer is opaque and the second layer translucent. It will be appreciated by one of ordinary skill that any of these attributes can be switched depending on the sensory experience desired.

In a non-limiting example, the first layer 110 has pH that is lower than the second layer 120. This variation in pH results in a tart tasting side (e.g., first layer) and a sweet tasting side (e.g., second layer). For example, the first layer 110 may have a pH of about 2.5 to about 4.0, and the second layer 120 may have a pH of about 3.2 to about 5.0. In some aspects, the pH of the first layer is about 2.6, alternatively about 2.7, alternatively about 2.8, alternatively about 2.9, alternatively about 3.0, alternatively about 3.1, alternatively about 3.2, alternatively about 3.3, alternatively about 3.4, alternatively about 3.5, alternatively about 3.6, alternatively about 3.7, alternatively about 3.8, or alternatively about 3.9. In some aspects, the pH of the second layer is about 3.3, alternatively about 3.4, alternatively about 3.5, alternatively about 3.6, alternatively about 3.7, alternatively about 3.8, alternatively about 3.9, alternatively about 4.0, alternatively about 4.1, alternatively about 4.2, alternatively about 4.3, alternatively about 4.4, alternatively about 4.5, alternatively about 4.6, alternatively about 4.7, alternatively about 4.8, or alternatively about 4.9. The first layer 110 may be opaque and the second layer 120 may be translucent.

While the multilayered confectionary 100 is shown as spherical in FIGS. 1-3, other shapes are contemplated including, but not limited to, ovoid, bean shaped, cylinders, worms, or ropes.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

It will be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A multilayered confectionary comprising a colloid blend, the colloid blend comprising gelatin and pectin,
wherein the multilayered confectionary comprises no more than two non-aerated layers,
a first layer and a second layer, each layer having at least two different attributes,
wherein at least one of the attributes is pH, and the pH of the first layer is lower than the pH of the second layer,
and the first layer and the second layer are formed by pre-gelling the colloid blend.

2. The multilayered confectionary of claim 1, wherein the pH of the first layer is from about 2.5 to about 4.0 and the pH of the second layer is from about 3.2 to about 5.0.

3. The multilayered confectionary of claim 1, wherein the colloid blend comprises about 5% pectin—about 95% pectin.

4. The multilayered confectionary of claim 1, wherein the colloid blend comprises about 95% gelatin—about 5% gelatin.

5. The multilayered confectionary of claim 1, wherein at least one attribute is selected from the group consisting of color, texture, flavor, appearance, taste, and aroma.

6. The multilayered confectionary of claim 5, wherein the attribute is appearance and wherein the first layer is translucent and the second layer is opaque;
or the first layer is opaque and the second layer translucent.

7. The multilayered confectionary of claim 1, wherein the colloid blend is pre-gelled by adjusting a gelling temperature.

8. The multilayered confectionary of claim 1, wherein the colloid blend is pre-gelled by an addition of at least one salt, at least one acid, and/or at least one solid to the colloid blend.

9. The multilayered confectionary of claim 8, wherein the salt is selected from the group consisting of a citrate salt, a phosphate salt, a malate salt, or combinations thereof.

10. The multilayered confectionary of claim 8, wherein the acid is selected from the group consisting of acetic acid, ascorbic acid, butyric acid, citric acid, tartaric acid, malic acid, lactic acid, fumaric acid, and combinations thereof.

11. A method of preparing multilayered confectionary comprising
providing a colloid blend comprising gelatin and pectin, and
pre-gelling the colloid blend to form no more than two non-aerated layers, wherein a first layer and a second layer each have at least two different attributes,
wherein at least one of the attributes is pH, and the pH of the first layer is lower than the pH of the second layer.

12. The method of claim 11, wherein the pH of the first layer is from about 2.5 to about 4.0 and the pH of the second layer is from about 3.2 to about 5.0.

13. The method of claim 11, wherein the colloid blend comprises about 5% pectin—about 95% pectin.

14. The method of claim 11, wherein the colloid blend comprises about 95% gelatin—about 5% gelatin.

15. The method of claim 11, wherein the at least one attribute is selected from the group consisting of pH, color, texture, flavor, appearance, taste, and aroma.

16. The method of claim 15, wherein the attribute is appearance and wherein the first layer is translucent and the second layer is opaque;
or the first layer is opaque and the second layer translucent.

17. The method of claim 11, wherein the colloid blend is pre-gelled by adjusting a gelling temperature.

18. The method of claim 11, wherein the colloid blend is pre-gelled by an addition of at least one salt, at least one acid, and/or at least one solid to the colloid blend.

19. The method of claim 18, wherein the salt is selected from the group consisting of a citrate salt, a phosphate salt, a malate salt, or combinations thereof.

20. The method of claim 19, wherein the acid is selected from the group consisting of acetic acid, ascorbic acid, butyric acid, citric acid, tartaric acid, malic acid, lactic acid, fumaric acid, and combinations thereof.
